(19) United States
(12) Patent Application Publication
(10) Pub. No.: US 2006/0020374 A1
(43) Pub. Date: Jan. 26, 2006

(54) Apparatus and method for directing an entry into an aircraft holding pattern

(76) Inventor: Paul Kenner, Denver, CO (US)

Correspondence Address: Paul Kenner, 704 Fairview Avenue, Belvedere, SC, 29841, US

(21) Appl. No.: 10/829,794

(22) Filed: Jul. 21, 2004

(51) Int. Cl. G06F 19/00

(52) U.S. Cl. 701/3; 701/4

(57) ABSTRACT

An aircraft aid and method for directing an optimal entry into an aircraft holding pattern are disclosed. The aircraft aid may be affixed over and in registry with a navigational instrument, displayed on and in registry with a navigational instrument, or placed over and in registry with a holding pattern entry diagram. The aircraft aid includes indicia for use in providing a visual for directing an optimal or proper entry into an aircraft holding pattern so that a pilot can have a pictorial view of the proper entry into a holding pattern. It is noted that this abstract is provided to comply with the rules requiring an abstract that will allow a searcher or other reader to ascertain quickly the subject matter of the technical disclosure and is not be used to interpret or limit the scope or meaning of the claims.

### FIELD OF THE INVENTION

The present invention relates to a device, navigational aid and or method that assists pilots in making the transition from ground training to actual flight. More particularly, the present invention relates to a navigational aid, device and/or method for directing a pilot into a holding pattern entry for an aircraft during flight.

### BACKGROUND OF THE INVENTION

One of the most difficult tasks for an inexperienced aircraft pilot to understand is the task of properly entering a hold pattern. A hold or fix is a point in the sky where an air traffic controller would like an aircraft to remain until conditions are better for that aircraft to proceed on its flight plan. In order to train pilots for entering a hold pattern, numerous hours are spent on the ground and in the air developing this skill. Previous methods for directing pilots into hold pattern entries have been focused on ground training without providing navigational aids for the pilot to use while in the aircraft. For example, a pilot may mentally rehearse hold pattern entry techniques on the ground while using legacy training devices such as a holding visualizer or a holding pattern computer. These legacy training devices help a pilot simulate holding pattern entry scenarios on the ground but are too cumbersome for a pilot to use in flight and can be confusing when used for ground purposes. Thus, it is difficult for a pilot to make the transition from ground scenarios to actual aircraft holding pattern entries. Specifically, legacy training devices require the pilot to maneuver movable settings on the device to match a simulated scenario in order to receive direction and determine the holding pattern entry that should be used. However, because the legacy training devices can be cumbersome to maneuver and confusing, making the necessary correlations from ground training to actual flight practice is hindered.

It is with respect to these considerations and others that the present invention has been made.

### SUMMARY OF THE INVENTION

Embodiments of the present invention address these problems and others by providing an apparatus and method for directing an optimal entry into an aircraft holding pattern. The apparatus and method enable a user to have a pictorial view of an optimal holding pattern entry during on-the-ground training and or in actual flight.

One embodiment of the present invention is an apparatus for directing an optimal entry into an aircraft holding pattern. The apparatus includes a transparent disc that has a center and a first side and may be removably affixed over a navigational instrument. The navigational instrument displays a heading of an aircraft and radials from a holding pattern fix of the aircraft. The transparent disc additionally includes indicia to be superimposed over the navigational instrument for use in directing an optimal entry into an aircraft holding pattern. The apparatus also includes a means for removably affixing the transparent disc to the navigational instrument such that the transparent disc is concentric with the navigational instrument. Thus, an aircraft pilot may have a pictorial view of an optimal entry into a holding pattern.

Another embodiment is a method for directing an optimal entry into an aircraft holding pattern. The method involves receiving an air traffic control instruction for an aircraft to enter a holding pattern and hold on a designated radial off of the holding pattern fix. A transparent disc is placed over in registry with a navigational instrument where the navigational instrument displays a heading of the aircraft and radials off of a holding pattern fix of the aircraft. In registry, for the purposes of this application is intended to mean a condition of correct alignment or proper relative position. The transparent disc also contains indicia for use in directing an optimal entry into an aircraft holding pattern. An optimal entry into a standard or nonstandard holding pattern is then directed based on the position the designated radial on the navigational instrument in relation to the indicia.

The method may also involve an on the ground training exercise where a holding pattern entry diagram is provided. The holding pattern entry diagram includes a circle with an indicator in the center of the circle representing a simulated holding pattern fix for an imaginary aircraft. The circle is divided into quadrants with the north direction represented at the zero (0) degree mark of the circle. The holding pattern entry diagram also includes a mark or a line indicating an angle representing the radial on which the imaginary aircraft will hold. The holding pattern entry diagram further includes another mark or line indicating an angle representing the heading of the imaginary aircraft approaching the simulated holding pattern fix. The transparent disc is placed over the holding pattern entry diagram such that a first side or the reverse side of the transparent disc is presented and the center of the transparent disc is concentric with the indicator of the circle. The optimal entry into a standard or a non-standard holding pattern for the imaginary aircraft is then directed based on a position of the mark or line representing the radial on which the imaginary aircraft will hold in relation to the indicia of the transparent disc. The dual capabilities of the transparent disc enable a pilot to easily make a transition from receiving direction and determining holding pattern entries during on-the-ground training to actual flight holding pattern entry determination.

Still another embodiment of the present invention may be an aircraft aid for directing an optimal entry into an aircraft holding pattern. The aircraft aid may be a device that can be removably affixed to and in registry with a navigational instrument. The device may also be placed over and in registry with a holding pattern entry diagram. The device includes indicia providing a visual for directing an optimal entry into an aircraft holding pattern whereby a pilot can have a pictorial view of the proper entry into a holding pattern.

Another embodiment of the present invention may be a navigational aid for directing an optimal entry into an aircraft holding pattern. For the purposes of this application a navigational aid includes information or indicia displayed on flight instruments during actual flight. The navigational aid includes indicia displayed via a navigational instrument display. The navigational instrument display identifies a heading of an aircraft and radials including a radial on which the aircraft will hold while in the aircraft holding pattern. The indicia displayed on the navigational instrument display includes an index aligned with the heading of the aircraft identified on the navigational instrument display and at least one section identifying the optimal entry for the aircraft having the heading and entering the holding pattern to hold on the radial identified by the navigational instrument display. The optimal entry is identified based on a position of the radial on which the aircraft will hold relative to the section identifying the optimal entry. Thus, a pilot can have a pictorial view of a proper entry into an aircraft holding pattern.

Still another embodiment of the present invention is a method for directing an entry into an aircraft holding pattern. The method involves displaying indicia via a navigational instrument display to direct the entry into the aircraft holding pattern. The navigational instrument display identifies a heading of an aircraft and radials on which the aircraft can hold. The method also involves directing the entry into the aircraft holding pattern based on a position of one of the radials, identified on the navigational instrument display and on which the aircraft will hold, in relation to the indicia displayed.

These and various other features as well as advantages, which characterize the present invention, will be apparent from a reading of the following detailed description and a review of the associated drawings.

### BRIEF DESCRIPTION OF THE DRAWINGS

FIG. 1A is a plan view of a disc illustrating an embodiment of the present invention;

FIG. 1B is an exploded perspective of the disc and electrostatic film for affixing the disc to and/or over a navigational instrument;

FIG. 2 is a plan view of the disc illustrating an embodiment of the present invention;

FIGS. 3A-3B illustrate a hypothetical holding pattern entry diagram used for on the ground training without and with placement of the disc of FIG. 1A in an embodiment of the present invention;

FIGS. 4A-4B are plan views of a navigational instrument without and with placement of the disc of FIG. 1 A in an embodiment of the present invention;

FIGS. 4C-4E illustrate optimal holding pattern entry diagrams corresponding to use of the transparent disc illustrated in FIG. 4B in an embodiment of the present invention;

FIGS. 5A-5D are plan views of the navigational instrument of FIG. 4A with placement of the transparent disc illustrated in FIG. 2 and corresponding optimal holding pattern entry diagrams in an embodiment of the present invention;

FIG. 6 is an illustrative block diagram and screen display generated from a graphics engine and illustrating a display of a navigational instrument for use in directing standard holding pattern entries in an embodiment of the present invention; and

FIG. 7 is an illustrative block diagram and screen display generated by the graphics engine and illustrating another display of the navigational instrument of FIG. 6 for use in directing non-standard holding pattern entries in an embodiment of the present invention.

### DETAILED DESCRIPTION

The present invention is more particularly described in the following examples that are intended as illustrative only since numerous modifications and variations therein will be apparent to those skilled in the art. Embodiments are now described with reference to the figures, in which like numbers indicate like parts throughout the figures.

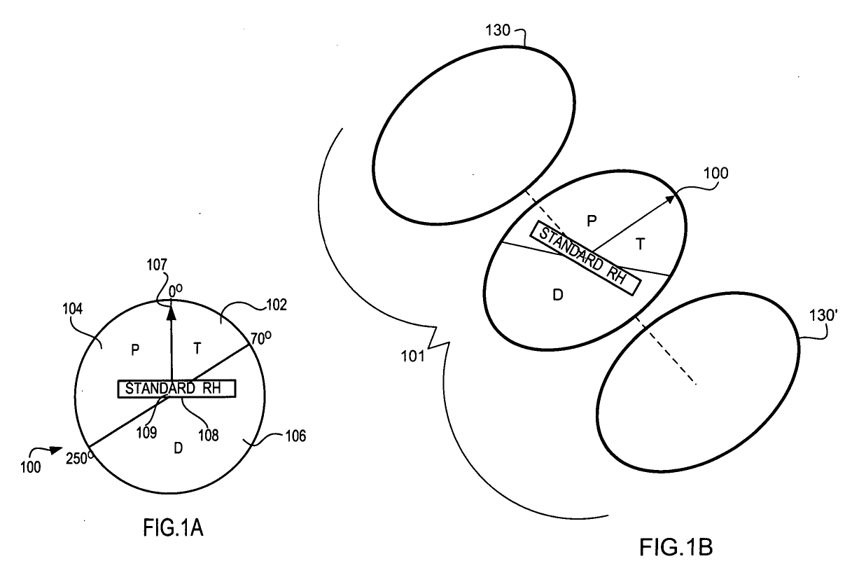

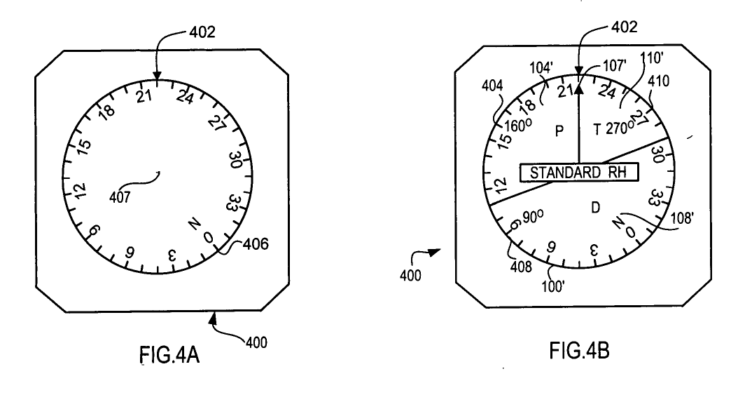

Referring now to FIGS. 1A and 1B, an apparatus for directing an optimal entry into an aircraft holding pattern in an embodiment of the present invention will be described. An embodiment of the present invention as illustrated in FIGS. 1A-1B comprises a disc 100 having indicia that may be superimposed over a navigational instrument or a holding pattern entry diagram. In alternative embodiments, the disc 100 may be transparent. Additional details regarding the navigational instrument and holding pattern entry diagrams will be described below with respect to FIGS. 3A-5D.

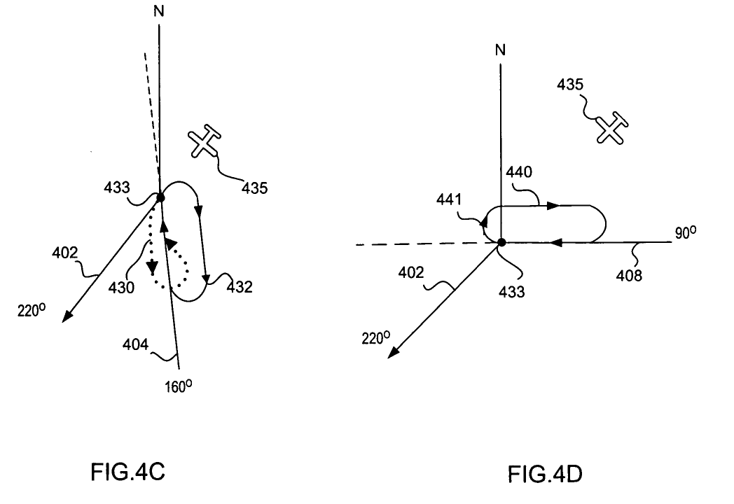

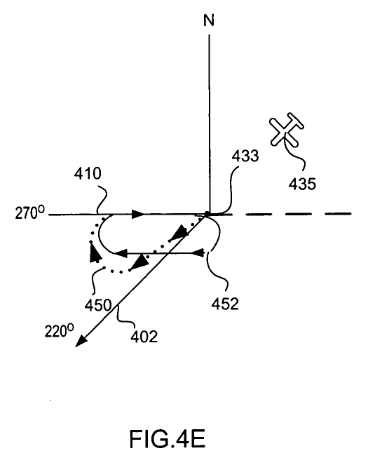

Referring again to FIG. 1A, the indicia identifies an index 107 of the transparent disc 100 to be aligned with the heading of an aircraft displayed on the navigational instrument or the heading of a holding pattern entry diagram for ground training or simulation. The indicia also radially divide the transparent disc into three sections 102, 104, and 106. Each section represents an area within which an optimal entry may be identified. Section 102 defines a teardrop entry and is represented by an area that spans 70 degrees in a clockwise direction from the index 107 about the center 109 of the disc 100. A parallel entry section 104 is represented by an area that spans 110 degrees in a counter-clockwise direction from the index 107 about the center 109 of the transparent disc 100. Lastly, a direct entry section 106 is represented by an area that spans 180 degrees about the center 109 of the transparent disc 100. The indicia may also distinguish each of the sections by a color, a letter, as is the case for the present embodiment, and or a name of the optimal entry identified within each of the sections. Additional details regarding teardrop, parallel, and direct entries will be described below with respect to FIGS. 4C-5D.

The indicia, via a label 108, further identifies whether the optimal entry identified is for a standard right hand holding pattern or a non-standard left hand holding pattern. The label 108 is for standard right hand holding patterns as indicated by the ‘STANDARD RH’printed on the label affixed to a first side of the disc 100.

FIG. 1B is an exploded perspective view of the disc 100 and electrostatic film 130 for affixing the disc 100 to and/or over a navigational instrument in an embodiment of the present invention. The apparatus 101 includes the disc 100 and an electrostatic film 130 to be removably adhered to the disc 100 to enable the disc to be removably affixed or adhered to a navigational instrument. The disc may be made of a variety of materials including bendable plastic that is transparent. The electrostatic film 130/130′ may also be transparent. In the alternative, the disc 100 may also be made of electrostatic film. It will be appreciated by those skilled in the art that other forms of affixing the disc 100 to the navigational instrument may also be used such as adhesive or sizing the disc diameter such that the disc 100 press fits within a recessed area over the face of the navigational instrument.

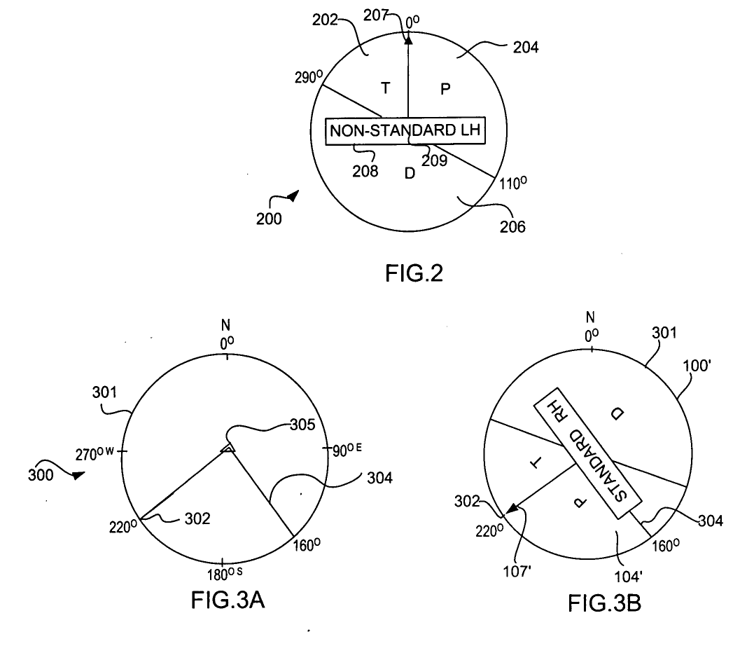

FIG. 2 is a plan view of the hold director for nonstandard holding pattern entries in an embodiment of the present invention. The disc 200 may be a separate disc or, in the alternative, be a reverse or opposite side of the disc 100. As similarly described above with respect to FIG. 1A, the indicia of the disc 200 identifies an index 207 of the disc 200 to be aligned with the heading of an aircraft displayed on a navigational instrument or the heading of a holding pattern entry diagram for ground training or simulation. The indicia also radially divide the disc 200 into three sections 202, 204, and 206. Each section represents an area within which an optimal entry may be identified. The teardrop entry section 202 is represented by an area that spans 70 degrees in a counterclockwise direction from the index 207 about the center 209 of the disc 200. The parallel entry section 204 is represented by an area that spans 110 degrees in a clockwise direction from the index 207 about the center 209 of the disc 200. Lastly, the direct entry section 206 is represented by an area that spans 180 degrees about the center 209 of the disc 200. The indicia may also distinguish each of the sections by a color, a letter, as is the case for the present embodiment, and or a name of the optimal entry identified within each of the sections. It should be appreciated that in the case where the disc 200 is the reverse side of the disc 100 that is transparent, the two sides of the disc may share indicia with the exception of the label 108.

The indicia, via a label 208, further identifies whether the optimal entry identified is for a standard right hand holding pattern or a non-standard left hand holding pattern. The label 208 is for nonstandard left hand holding patterns as indicated by the ‘NON-STANDARD LH’ printed on the label affixed to the transparent disc 200.

FIGS. 3A-3B illustrate a hypothetical holding pattern entry diagram without and with placement of the disc 100 of FIG. 1A used for on the ground training in an embodiment of the present invention. For the purposes of describing FIGS. 3A-3B, the disc 100′ is transparent. A holding pattern entry diagram 300 is drawn for use in an on the ground training exercise for directing an optimal entry into a holding pattern. A circle 301 is drawn with an indicator 305 in the center of the circle representing a simulated holding pattern fix for an imaginary aircraft. The circle is then divided into quadrants with a north direction represented at a 0 degree mark of the circle 301, an east direction represented at a 90 degree mark, a south direction represented at a 180 degree mark, and a west direction represented at a 270 degree mark.

A radial on which the imaginary aircraft is to hold and a heading at which the imaginary aircraft approaches the simulated holding pattern fix are then selected. A line 304 is drawn from the indicator 305 that intersects the circle 301 at an angle representing the radial. As illustrated in FIG. 3A, the radial selected is the 160 degree radial, southeast standard holding pattern. A heading line 302 is drawn from the indicator 305 that intersects the circle 301 at an angle representing the heading selected. In FIG. 3A, the heading of 220 degrees southwest has been selected. The transparent disc 100′ is placed over the circle 301 such that the center 109 of the transparent disc 100′ is concentric with the indicator 305 and the index 107′ is substantially aligned with the heading line 302 of the holding pattern entry diagram 300.

Next an optimal entry into a standard holding pattern is directed for the imaginary aircraft based on the position of the line 304, representing the radial selected, in relation to the indicia of the transparent disc 100′. Because the line 304 is positioned within the parallel entry section 104′, the optimal and recommended entry into a standard holding pattern holding on the southeast 160 radial for an aircraft heading 220 degrees southwest is the parallel entry described below. Thus, a pilot can easily make a transition from determining holding pattern entries during on the ground training to receiving holding pattern entry direction from the transparent disc 100′ during actual flight. Additional details regarding receiving holding pattern entry direction during flight will be described below with respect to FIGS. 4A-5D.

FIGS. 4A-4B are plan views of a navigational instrument 400 without and with placement of the transparent disc 100′ of FIG. 3B in an embodiment of the present invention. FIG. 4A illustrates a navigational instrument 400. The navigational instrument displays a heading 402 of an aircraft while the aircraft is in flight, in this case the heading is 220 degrees southwest. Thus, the navigational instrument accordingly rotates as the heading of an aircraft changes. The navigational instrument 400 also displays radials from a holding pattern fix of the aircraft where the zero (0) degree radial 406 represents true north. The transparent disc 100′ includes indicia to be superimposed over the navigational instrument 400 for use in directing an optimal entry into an aircraft holding pattern as illustrated in FIG. 4B.

Referring also to FIG. 4B, a means for affixing the transparent disc 100′, such as the electrostatic film 130 described above with respect to FIG. 1A, is utilized to removably affix the transparent disc 100′ over or to the navigational instrument 400 such that the transparent disc 100′ is concentric with a center 407 of the navigational instrument. Also, the index 107′ is substantially aligned with the heading 402 of the aircraft, which in FIG. 4B is 220 degrees southwest. It should be appreciated that the transparent disc 100′ may be the same, smaller, or larger in diameter as compared to the face of the navigational instrument 400. When the disc is not transparent, the diameter may be smaller than the face of the navigational instrument such that the radials of the navigational instrument 400 appear just above the circumference of the disc.

The indicia of the transparent disc 100′ also distinguishes each of the sections 104′, 108′, and 110′ as representing an area within which an optimal entry into aircraft holding patterns is identified. The sections 104′, 108′, and 110′ respectively identify optimal entries into aircraft holding patterns holding on a radial displayed on the navigational instrument 400 and over which at least one of the sections 104′, 108′, and 110′ is superimposed. As a result, the aircraft pilot will have a pictorial view of an optimal entry into a holding pattern. Additional details regarding optimal holding pattern entries represented by the sections 104′, 108′, and 110′ are described below with respect to FIGS. 4C-4E.

FIG. 4C is a holding pattern entry diagram illustrating a holding pattern 432 and an entry 430 for an actual flight. In response to receiving an air traffic control instruction to hold southeast on the 160 radial 404, the pilot flying the aircraft 435 may view the navigational instrument 400 through the transparent disc 100′ and see the optimal entry for the holding pattern. As seen in FIG. 4B, the 160 radial 404 is displayed within the parallel entry section 104′ for the aircraft 435 approaching a holding pattern fix 433 at a heading 402 of 220 degrees southwest.

For aircraft approaching a fix 433 at a heading 402 of 220 degrees southwest to hold on the 160 radial 404, a parallel entry 432 would require a minimum number of turns to enter the holding pattern 432 and is thus, the optimal entry directed by the transparent disc 100′. A pilot may begin a parallel entry 430 after the aircraft 435 crosses the fix 433 which marks the start of the outbound leg time, which is usually one minute. After crossing the fix 433, the pilot should turn to the heading of the radial 404 that the hold is predicated on, in this case 160 southeast. After one minute and flying parallel to the radial 404, the aircraft 435 should be turned back on the protected side of the aircraft to the fix 433. For a standard holding pattern, a turn to the protected side in a parallel entry would be a left turn

FIG. 4D is a holding pattern entry diagram illustrating a holding pattern 440 and an entry 441 for an actual flight. In response to receiving an air traffic control instruction to hold east on the 90 radial 408, the pilot flying the aircraft 435 may view the navigational instrument 400 through the transparent disc 100′ and see the optimal entry for the holding pattern. As seen in FIG. 4B, the 90 radial 408 is displayed within the direct entry section 108′ for the aircraft 435 approaching a holding pattern fix 433 at a heading 402 of 220 degrees southwest.

For aircraft approaching a fix 433 at a heading 402 of 220 degrees southwest to hold on the 90 radial 408, a direct entry 441 would require a minimum number of turns to enter the holding pattern 432 and is thus, the optimal entry directed by the transparent disc 100′. A pilot may begin a direct entry 441 after the aircraft 435 crosses the fix 433. After crossing the fix 433, the pilot should turn to the heading of the radial 408 that the hold is predicated on, in this case 90 east. For a standard holding pattern the turn should be a right turn. When the aircraft 435 becomes abeam the fix, the time for an outbound leg is begun, usually one minute. The aircraft 435 proceeds for one minute and then a right turn is made to intercept the 90 east radial 408 on which the hold is predicated.

FIG. 4E is a holding pattern entry diagram illustrating a holding pattern 452 and an entry 450 for an actual flight. In response to receiving an air traffic control instruction to hold west on the 270 radial 410, the pilot flying the aircraft 435 may view the navigational instrument 400 through the transparent disc 100′ and see the optimal entry for the holding pattern. As seen in FIG. 4B, the 270 radial 410 is displayed within the teardrop entry section 110′ for the aircraft 435 approaching a holding pattern fix 433 at a heading 402 of 220 degrees southwest.

For aircraft approaching a fix 433 at a heading 402 of 220 degrees southwest to hold on the 270 radial 410, a teardrop entry 450 would require a minimum number of turns to enter the holding pattern 452 and is thus, the optimal entry directed by the transparent disc 100′. A pilot may begin a teardrop entry 450 after the aircraft 435 crosses the fix 433. After crossing the fix 433 for standard holding patterns, the pilot should turn to the heading of the radial 410 that the hold is predicated on minus 30 degrees, in this case 270 west−30=240 southwest. The aircraft 435 then proceeds outbound for one minute and makes a turn to intercept the 270 radial 410 on which the hold is predicated. For a standard holding pattern the turn should be a right turn.

FIG. 5A is a plan view of the navigational instrument 400 with placement of the transparent disc 200′ illustrated in FIG. 2 in an embodiment of the present invention. The navigational instrument 400 displays a heading 402 of an aircraft while the aircraft is in flight, in this case the heading is 220 degrees southwest. The navigational instrument 400 also displays radials from a holding pattern fix of the aircraft where the zero (0) degree radial 406 represents true north. The transparent disc 200′ contains indicia to be superimposed over the navigational instrument 400 for use in directing an optimal entry into a non-standard aircraft holding pattern as illustrated in FIG. 5A.

Still referring to FIG. 5A for nonstandard holding patterns, a means for affixing the transparent disc 200′, such as the electrostatic film 130 described above with respect to FIG. 1A, is utilized to removably affix the transparent disc 200′ over the navigational instrument 400 such that the transparent disc 200′ is concentric with a center 407, shown in FIG. 4A, of the navigational instrument. Also, the index 207′ is substantially aligned with the heading 402 of the aircraft, for example 220 degrees southwest. It should be appreciated that the transparent disc 200′ may be the same, smaller, or larger in diameter as the face of the navigational instrument 400. It should also be appreciated that the transparent disc 200′ may be the opposite side of the transparent disc 100′. If the disc is not transparent as, the diameter may be smaller than the face of the navigational instrument such that the radials of the navigational instrument 400 appear just above the circumference of the disc.

The indicia of the transparent disc 200′ also distinguishes each of the sections 202′, 204′, and 206′ as representing an area within which an optimal entry into nonstandard aircraft holding patterns is identified. The sections 202′, 204′, and 206′ respectively identify optimal entries into aircraft holding patterns holding on a radial displayed on the navigational instrument 400 and over which at least one of the sections 202′, 204′, and 206′ is superimposed. As a result, the aircraft pilot will have a pictorial view of an optimal entry into a holding pattern. Additional details regarding optimal holding pattern entries represented by the sections 202′, 204′, and 206′ are described below with respect to FIGS. 5B-5D.

FIG. 5B is a holding pattern entry diagram illustrating a holding pattern 518 and an entry 520 for an actual flight. In response to receiving an air traffic control instruction to hold southeast on the 160 radial 404 nonstandard or left turns, the pilot flying the aircraft 435 may view the navigational instrument 400 through the transparent disc 200′ and see the optimal entry for the holding pattern. As seen in FIG. 5A, the 160 radial 404 is displayed within the teardrop entry section 202′ for the aircraft 435 approaching a nonstandard holding pattern fix 433 at a heading 402 of 220 degrees southwest.

For aircraft approaching a fix 433 at a heading 402 of 220 degrees southwest to execute a nonstandard hold on the 160 radial 404, a teardrop entry 520 would require a minimum number of turns to enter the holding pattern 518 and is thus, the optimal entry directed by the transparent disc 200′. A pilot may begin a teardrop entry 520 after the aircraft 435 crosses the fix 433. After crossing the fix 433 for nonstandard holding patterns, the pilot should turn to the heading of the radial 404 that the hold is predicated on plus 30 degrees, in this case 160 southeast+30=190 southwest. The aircraft 435 then proceeds outbound for one minute and makes a turn to intercept the 160 radial 404 on which the hold is predicated. For a nonstandard holding pattern the turn should be a left turn.

FIG. 5C is a holding pattern entry diagram illustrating a holding pattern 530 and an entry 528 for an actual flight. In response to receiving an air traffic control instruction to execute a nonstandard hold east on the 90 radial 408, the pilot flying the aircraft 435 may view the navigational instrument 400 through the transparent disc 200′ and see the optimal entry for the holding pattern. As seen in FIG. 5A, the 90 radial 408 is displayed within the direct entry section 206′ for the aircraft 435 approaching a nonstandard holding pattern fix 433 at a heading 402 of 220 degrees southwest.

For aircraft approaching a fix 433 at a heading 402 of 220 degrees southwest to execute a nonstandard hold on the 90 radial 408, a direct entry 528 would require a minimum number of turns to enter the holding pattern 530 and is thus, the optimal entry directed by the transparent disc 200′. A pilot may begin a direct entry 528 after the aircraft 435 crosses the fix 433. After crossing the fix 433, the pilot should turn to the heading of the radial 408 that the hold is predicated on, in this case 90 east. For a nonstandard holding pattern the turn should be a left turn. When the aircraft 435 becomes abeam the fix, the time for an outbound leg is begun, usually one minute. The aircraft 435 proceeds for one minute and then a left turn is made to intercept the 90 east radial 408 on which the hold is predicated.

FIG. 5D is a holding pattern entry diagram illustrating a holding pattern 542 and an entry 540 for an actual flight. In response to receiving an air traffic control instruction to execute a nonstandard hold west on the 270 radial 410, the pilot flying the aircraft 435 may view the navigational instrument 400 through the transparent disc 200′ and see the optimal entry for the holding pattern. As seen in FIG. 5D, the 270 radial 410 is displayed within the parallel entry section 204′ for the aircraft 435 approaching a holding pattern fix 433 at a heading 402 of 220 degrees southwest.

For aircraft approaching a fix 433 at a heading 402 of 220 degrees southwest to execute a nonstandard hold on the 270 radial 410, a parallel entry 540 would require a minimum number of turns to enter the holding pattern 542 and is thus, the optimal entry directed by the transparent disc 200′. A pilot may begin a parallel entry 540 after the aircraft 435 crosses the fix 433 and marks the start of the outbound leg time, which is usually one minute. After crossing the fix 433, the pilot should turn to the heading of the radial 410 that the hold is predicated on, in this case 270 west. After one minute of flying parallel to the radial 410, the aircraft 435 should be turned back on the protected side of the aircraft to the fix 433. For a nonstandard holding pattern, a turn to the protected side in a parallel entry would be a right turn.

The transparent disc 200′ is preferably formed of a bendable material such as plastic. Examples of plastics that may be used to form the transparent discs include, but are not limited to polypropylene and electrostatic film.

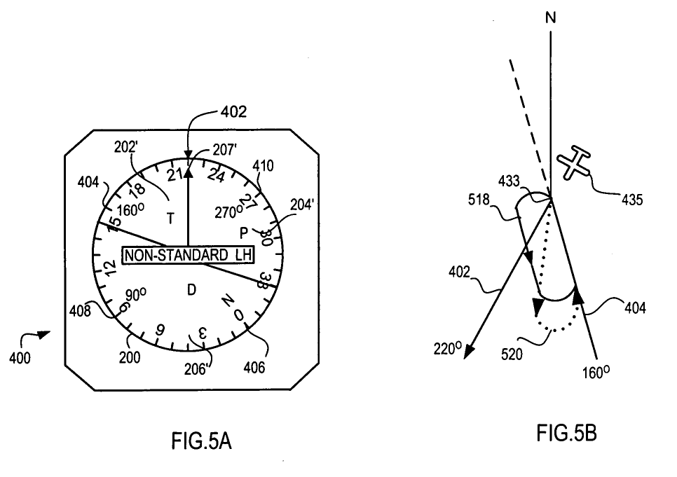

FIG. 6 is an illustrative block diagram and screen display generated from a graphics engine 605 illustrating a display 603 of a navigational instrument 600 for use in directing standard holding pattern entries in an embodiment of the present invention. One skilled in the art will recognize that the graphics display 603 may be a liquid crystal display (LCD) utilizing digital signals. The graphics display 603 may also include a cathode ray tube (CRT) utilizing a graphics display system, such as a video graphics array (VGA) utilizing analog signals. In addition to displaying a heading 602 of the aircraft and other radials, the display 603 displays indicia that identify an index 607 aligned with the heading 602 of the aircraft. The indicia also radially divide the graphic display 603 into three sections 601, 604, and 606.

Each section represents an area within which an optimal entry into a holding pattern is identified for holding radials displayed within the respective section as the index aligns with the heading 602. Section 601 defines a teardrop entry and is represented by an area that spans 70 degrees in a clockwise direction from the index 607 about the center 609 of the display 603. A parallel entry section 604 is represented by an area that spans 110 degrees in a counterclockwise direction from the index 607 about the center 609 of the display 603. Lastly, a direct entry section 606 is represented by an area that spans 180 degrees about the center 609 of the display 603. The indicia may also distinguish each of the sections by a letter, as is the case for the present embodiment, a color, and or a name of the optimal entry identified within each of the sections.

The sensor 608 provides navigational inputs to the graphics engine 605. Thus, as the heading 602 of the aircraft changes, the sensor 608 detects the change and provides corresponding inputs to the graphics engine 605. The graphics engine 605 then updates the display 603 to display the new heading 602 and updates the index 607 to align with the new heading 602. The indicia, via an indicator 611, may further identify whether the optimal entry identified is for a standard right hand holding pattern or a non-standard left hand holding pattern. The indicator 611 is for standard right hand holding patterns as indicated by the ‘STD RH’ displayed on the graphic display 603.

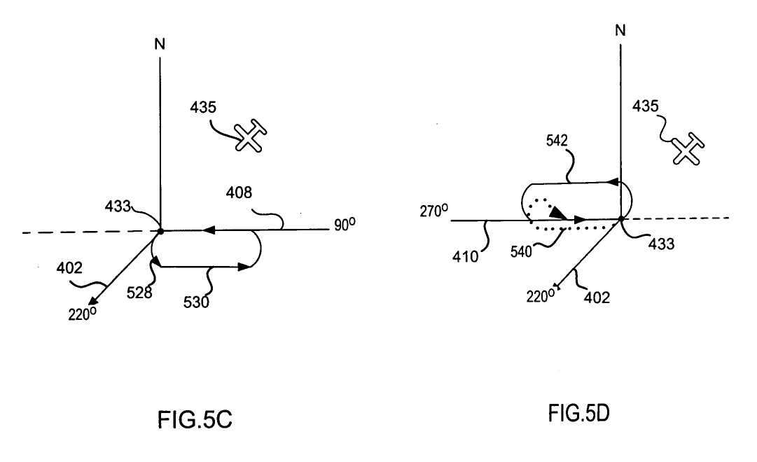

FIG. 7 is an illustrative block diagram and screen display generated by the graphics engine 605 and illustrating the display 603 of the navigational instrument 600 of FIG. 6 for use in directing non-standard holding pattern entries in an embodiment of the present invention. In addition to displaying a heading 602 of the aircraft and other radials, the display 603 displays indicia that identify the index 607 aligned with the heading 602 of the aircraft. The indicia also radially divide the graphic display 603 into three sections 701, 704, and 706.

Each section represents an area within which an optimal entry into a holding pattern is identified for holding radials displayed within the respective section as the index 607 aligns with the heading 602. Section 701 defines a teardrop entry and is represented by an area that spans 70 degrees in a counterclockwise direction from the index 607 about the center 609 of the display 603. A parallel entry section 704 is represented by an area that spans 110 degrees in a clockwise direction from the index 607 about the center 609 of the display 603. Lastly, a direct entry section 706 is represented by an area that spans 180 degrees about the center 609 of the display 603. The indicia may also distinguish each of the sections by a letter, as is the case for the present embodiment, a color, and or a name of the optimal entry identified within each of the sections.

The sensor 608 provides navigational inputs to the graphics engine 605. Thus, as the heading 602 of the aircraft changes, the sensor 608 detects the change and provides corresponding inputs to the graphics engine 605. The graphics engine 605 then updates the display 603 to display the new heading 602 and updates the index 607 to align with the new heading 602. The indicia, via an indicator 711, may further identify whether the optimal entry identified is for a standard right hand holding pattern or a non-standard left hand holding pattern. The indicator 711 is for nonstandard left hand holding patterns as indicated by the ‘NSTD LH’ displayed on the graphic display 603.

Thus, the present invention is presently embodied as a method and apparatus for directing an entry into an aircraft holding pattern.

Although the present invention has been described with reference to specific details of certain embodiments thereof, it is not intended that such details should be regarded as limitations upon the scope of the invention except as and to the extent that they are included in the accompanying claims.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An apparatus for directing an optimal entry into an aircraft holding pattern comprising:
a transparent disc having a center and a first side, the transparent disc to be removably affixed to, concentric with, and in registry with a navigational instrument wherein the navigational instrument displays a heading of an aircraft and a plurality of radials from a holding pattern fix of the aircraft and wherein the transparent disc is superimposed over the navigational instrument for use in directing an optimal entry into an aircraft holding pattern.

2. The apparatus of claim 1, further comprising means for removably affixing the transparent disc to the navigational instrument.

3. The apparatus of claim 1, wherein the transparent disc includes:
at least two sections radially divided about the center; and
an index aligned with the heading displayed on the navigational instrument wherein the at least two sections include at least one section that identifies an optimal entry for the aircraft having the heading and entering the holding pattern to hold on one of the plurality of radials displayed on the navigational instrument within the at least one section whereby an aircraft pilot has a pictorial view of a proper entry into a holding pattern.

4. The apparatus of claim 3, wherein the transparent disc further includes a reverse side to be removably affixed to, concentric with, and in registry with the navigational instrument and wherein the transparent disc is reversible such that:
optimal entries into standard right hand holding patterns are identified via the first side of the transparent disc; and
optimal entries into non-standard left hand holding patterns are identified via the reverse side of the transparent disc.

5. The apparatus of claim 4, wherein the transparent disc further includes a first label and a second label wherein the first label affixed to the first side indicates that optimal entries into standard right hand holding patterns are identified via the first side; and wherein the second label affixed to the reverse side indicates that optimal entries into non-standard left hand holding patterns are identified via the reverse side.

6. The apparatus of claim 3, wherein the transparent disc distinguishes each of the at least two sections by at least one of a color, a letter, and a name of the optimal entry identified within each of the at least two sections.

7. The apparatus of claim 3, wherein the plurality of radials displayed within each of the at least two sections change as the heading of the aircraft changes and the navigational instrument accordingly changes.

8. The apparatus of claim 7, wherein optimal entries identified by the at least two sections comprise at least two of the following:
a parallel entry represented by one of the at least two sections and spanning at least 110 degrees from the index about the center of the of the transparent disc;
a direct entry represented by one of the at least two sections and spanning at least 180 degrees about the center of the transparent disc; and
a teardrop entry represented by one of the at least two sections and spanning at least 70 degrees from the index about the center of the transparent disc.

9. The apparatus of claim 2, wherein the means for removably affixing the transparent disc to the navigational instrument comprises a transparent electrostatic film removably adhering to the transparent disc and the navigational instrument.

10. The apparatus of claim 1, wherein the transparent disc is made from at least one of plastic and electrostatic film.

11. A method for directing an entry into an aircraft holding pattern comprising:
providing a disc, wherein the disc is placed in registry with a navigational instrument that displays a heading of an aircraft and radials off of a holding pattern fix of the aircraft and wherein the disc includes indicia directing an entry into an aircraft holding pattern; and
directing an entry into at least one of a standard holding pattern entry and a non-standard holding pattern entry based on a position of a one of the radials, displayed on the navigational instrument and on which the aircraft will hold, in relation to the indicia of the disc whereby an aircraft pilot may have a pictorial view of an optimal entry into a holding pattern.

12. The method of claim 11, wherein the one of the radials on which the aircraft will hold is identified based on a navigational instruction received for the aircraft to enter the holding pattern and hold on the one of the radials.

13. The method of claim 11, in an on-the-ground training exercise, further comprising:
providing a holding pattern entry diagram including a circle having an indicator in the center of the circle representing a simulated holding pattern fix for an imaginary aircraft wherein the circle is divided into quadrants with a north direction represented at a zero degree mark of the circle and wherein the diagram further includes:
a first mark indicating a first angle representing a simulated radial on which the imaginary aircraft is to hold;
a second mark indicating a second angle representing a simulated heading at which the imaginary aircraft approaches the simulated holding pattern fix wherein the disc is placed over the circle such that one of a first side and a reverse side of the disc is presented and wherein the index is aligned with the second mark; and
directing an entry into at least one of a standard holding pattern and a non-standard holding pattern for the imaginary aircraft based on a position of the first mark in relation to the indicia whereby a pilot can easily make a transition from determining holding pattern entries during on the ground training to actual flight holding pattern entry determination.

14. The method of claim 13, wherein the disc is transparent and wherein the indicia is superimposed over one of the navigational instrument and the holding pattern entry diagram and wherein the indicia is effective to:
radially divide the disc into at least two sections;
identify an index of the disc aligned with at least one of the heading of the aircraft displayed on the navigational instrument and the simulated heading selected; and
distinguish the at least two sections as representing at least one section within which an entry into aircraft holding patterns is identified for aircraft holding on at least one of:
the one of the radials displayed on the navigational instrument and over which the at least one section is superimposed; and
the simiulated radial selected on which the imaginary aircraft is to hold and over which the at least one section is superimposed; and
wherein the transparent disc is one of removably affixed to the navigational instrument and placed over the circle such that the transparent disc is concentric with one of the navigational instrument and the circle; and
wherein directing the entry into at least one of the standard holding pattern and the non-standard holding pattern for the imaginary aircraft based on the position of the first mark in relation to the indicia comprises presenting which at least one section is superimposed over the first mark; and
wherein directing the entry into at least one of the standard holding pattern and the non-standard holding pattern based on the position of the one of the radials, displayed on the navigational instrument and on which the aircraft will hold, in relation to the indicia of the disc comprises presenting which at least one section is superimposed over the one of the radials.

15. An aircraft aid for directing an optimal entry into an aircraft holding pattern comprising:
a device including a first side and a center, the device at least one of removably affixed in registry with a navigational instrument and placed over in registry with a holding pattern entry diagram, the device including indicia providing a visual for directing an optimal entry into an aircraft holding pattern whereby a pilot can have a pictorial view of the proper entry into a holding pattern.

16. The device of claim 15, further comprising means for removably affixing the device to the navigational instrument.

17. The device of claim 16, wherein the means for removably affixing the device to the navigational instrument comprises an electrostatic film that removably adheres to the device and to the navigational instrument.

18. The device of claim 15, wherein the first side is effective to present the indicia directing an optimal entry into a standard holding pattern entry further comprising an opposite side, the opposite side being effective to present the indicia directing an optimal entry into a nonstandard holding pattern.

19. The device of claim 15, wherein the indicia is effective to:
divide the device into at least two sections about the center;
identify an index of the device to be aligned with at least one of the heading of an aircraft displayed on the navigational instrument and a simulated heading of an imaginary aircraft shown on the holding pattern entry diagram; and
distinguish the at least two sections as representing at least one section within which an optimal entry into aircraft holding patterns is identified for the aircraft holding patterns holding on at least one of:
a radial displayed on the navigational instrument and within a range of the at least one section; and
a simulated radial shown on the holding pattern entry diagram and within a range of the at least one section; and
wherein the index of the device is aligned with one of the heading of an aircraft displayed on the navigational instrument and the simulated heading shown on the holding pattern entry diagram.

20. The device of claim 19, wherein the indicia distinguishes each of the at least two sections by at least one of a color, a letter, and a name of the optimal entry identified within each of the at least two sections.

21. The device of claim 18, wherein the optimal entry comprises at least one of the following:
a parallel entry represented by a one of the at least two sections and spanning at least 110 degrees from the index about the center of the of the device;
a direct entry represented by a one of the at least two sections and spanning at least 180 degrees about the center of the device; and
a teardrop entry represented by a one of the at least two sections and spanning at least 70 degrees from the index about the center of the device.

22. A navigational aid for directing an optimal entry into an aircraft holding pattern comprising:
indicia displayed via a navigational instrument display wherein the navigational instrument display having a center identifies a heading of an aircraft and a plurality of radials including a radial on which the aircraft will hold while in the aircraft holding pattern and wherein the indicia comprises:
an index aligned with the heading of the aircraft identified on the navigational instrument display;
at least one section identifying the optimal entry for the aircraft having the heading and entering the holding pattern to hold on the radial identified by the navigational instrument display wherein the optimal entry identified is based on a position of the radial on which the aircraft will hold relative to the at least one section and whereby a pilot has a pictorial view of a proper entry into an aircraft holding pattern.

23. The navigational aid of claim 22, wherein the indicia distinguishes the at least one section by at least one of a color, a letter, and a name of the optimal entry identified within the at least one section.

24. The navigational aid of claim 22, wherein the navigational instrument display comprises one of a LCD and a VGA and wherein the position of the radial relative to the at least one section changes as the heading of the aircraft changes and the navigational instrument display accordingly updates the heading.

25. The navigational aid of claim 22, wherein the optimal entry identified by the at least one section comprises at least one of the following:
a parallel entry spanning at least 110 degrees from the index about the center of the of the navigational instrument display;
a direct entry spanning at least 180 degrees about the center of the navigational instrument display; and
a teardrop entry spanning at least 70 degrees from the index about the center of the navigational instrument display.

26. A method for directing an entry into an aircraft holding pattern comprising:
displaying indicia via a navigational instrument display to direct the entry into the aircraft holding pattern wherein the navigational instrument display identifies a heading of an aircraft and radials on which the aircraft can hold; and
directing the entry into the aircraft holding pattern based on a position of a one of the radials, identified on the navigational instrument display and on which the aircraft will hold, in relation to the indicia displayed.

27. The method of claim 26, wherein displaying the indicia comprises:
radially dividing the navigational instrument display into at least one section within which the entry into the aircraft holding pattern is identified;
identifying an index aligned with the heading identified on the navigational instrument display; and
distinguishing the at least one section by at least one of a letter, a color, and a name identifying the entry on the navigational instrument display; and
wherein directing the entry into the aircraft holding pattern based on the position of the one of the radials in relation to the indicia comprises:
rendering the one of the radials within the at least one section whereby a pilot has a pictorial view of a proper entry into an aircraft holding pattern.
